(19) United States
(12) Patent Application Publication
(10) Pub. No.: US 2026/0253476 A1
(43) Pub. Date: Aug. 27, 2026

(54) VISUAL ALERT DEVICE

(71) Applicant: ISAR LLC, Kennebunkport, ME (US)

(72) Inventor: David L. Smith, Kennebunkport, ME (US)

(73) Assignee: ISAR LLC, Kennebunkport, ME (US)

(21) Appl. No.: 19/452,842

(22) Filed: Jan. 19, 2026

Related U.S. Application Data
(60) Provisional application No. 63/748,074, filed on Jan. 22, 2025.

(51) Int. Cl. G08B 5/00; F21S 9/02; F21V 21/08; F21V 21/088; F21V 23/04; F21W 111/10; F21W 131/208; F21Y 115/10; G08B 5/36

(52) U.S. Cl. CPC G08B 5/002; F21S 9/022; F21V 21/0808; F21V 21/0816; F21V 21/088; F21V 23/04; G08B 5/36; F21W 2111/10; F21W 2131/208; F21Y 2115/10

(57) ABSTRACT

A visual alert device including a light which may be manually activated to alert other individuals of the need for assistance. The visual alert device is used by an individual in a hospital, combat support hospital, during an emergency event, or other situation in which the individual may alert a caregiver of the need for assistance. The light alert system has a light source, a power source, and a control mechanism coupled to the power source. The device may be temporarily or permanently attached to beds, stretchers, wheelchairs, or other such structures.

### BACKGROUND OF THE INVENTION

### 1. Field of the Invention

The present invention relates to a visual alert device. More specifically, the present invention relates to a visual alert signaling light device which may be used for visual notification when assistance is required.

### 2. Description of the Prior Art

Currently, there exists methods in which a patient who is located on a stretcher, wheelchair, or otherwise immobile, may alert medical staff of a need or issue. Typically, medical staff is alerted of a need or issue with a technological alert system called a call bell. The call bell allows a patient or other nearby person to press a button on a remote control to alert medical staff that attention is needed. The call bell is typically attached to a wall or medical bed where the patient may reach the remote to alert for help.

In some hospitals or medical facilities, occupancy may be an issue, forcing patients to wait or be treated in hallways, rooms, or other areas not equipped with call bells. Stretchers or wheelchairs may be located away from the typical medical facility call system and be unable to alert staff in times of need. In these situations, patients may be required to yell for attention, send a family member or visitor to seek help, ask any nearby hospital employee, or get up and wander until a medical staff member is located. Often times, patients would not seek assistance because of this issue. Alternatively, the patient may, unsafely or against medical orders, get up, move around, or otherwise put themselves at risk to remedy the issue.

The call bell system has developed over time to include items such as wearable technology, wireless monitoring and alarms, patient response monitoring systems, and mobile monitoring devices. These methods typically rely on patients being required to either possess the specific type of technological device used or be connected to a system with a central monitoring station.

Many regulatory and certifying organizations require that patients have access to a call system or method of alerting staff for safety reasons. Patients who are in a hallway or even as they wait in the waiting room are at risk, usually do not have any way to alert staff, and subsequently, facilities are often out of compliance with these hallway-located patients wait for a room to open that has the usual patient alert system within reach.

What is needed is a system that is simple to deploy, easy to clean between patients, is durable, and provides a simple visual alert to a caregiver that a person is in need of assistance regardless of the person's location in a care-giving facility.

### SUMMARY OF THE INVENTION

The present invention is a visual alert device operable by a patient or any type of person in need of assistance. The device is configured to enable the person to alert a caregiver of the need for attention when the person is in a location where no other notification method is available. Common examples of when and where this situation exists are in the hallways of Emergency Departments, in waiting areas, in hospital hallways of in-patient floors, and in common areas of residential facilities such as a dining area, common room, or patio. The present invention is also effective in an open ward situation for military combat support hospitals or during an emergency event in expedited FEMA hospitals where stretchers are the primary bedding solution.

The visual alert device includes a light, a power source, and a control mechanism. The light, when activated, glows sufficiently to be noticed, including in well-lit areas. The light is manually activated by the person in need via a switch that they control. The intent is for the light to be activated and remain on until a caregiver has arrived at which point they can turn it off and respond to the person. The switch is connected to the light, via a flexible cord but not limited thereto, wherein the light can be positioned in a variety of locations on a stretcher, wheelchair, or other support structure. It is also possible to permanently attach the unit to a stretcher by running the switch through openings if the stretcher has a design with openings large enough to run the switch and wire through them. There is an option for wire connections to be made to the switch after running the wire through narrow openings that are too small for the switch housing to pass through.

The device power source may be a battery sufficient to illuminate the light. The control mechanism may be a switch or button. Typically, the switch or button is a push-button momentary lock switch. The switch or button may be activated by the person to cause the light to turn on. The light will remain on until the person is attended to by a caregiver.

The components of the visual alert device may be made of a variety of materials. It is an aspect of the present invention that one or more components are hypoallergenic. The components may also be cleaned with alcohol-based wipes to meet hospital standards for infection control and to ensure patient safety.

### BRIEF DESCRIPTION OF THE DRAWINGS

FIG. 1 is a top perspective view of a first embodiment of the visual alert device of the present invention.

FIG. 2A is an exploded view of the switch assembly of FIG. 1.

FIG. 2B is a side view of the switch assembly of FIG. 1 fully assembled.

FIG. 3 is an exploded view of the ball and electronics assembly of FIG. 1 of the present invention.

FIG. 4A is a top view of the light assembly of FIG. 1. FIG. 4B is a bottom view of the light assembly of FIG. 1.

FIG. 5A is a circuit schematic diagram of the electronics of the light generator of the present invention.

FIG. 5B is an exploded view of the electrical components of the present invention.

FIG. 6A is a depiction of the present invention in use with a stretcher.

FIG. 6B is a depiction of the present invention in use with a wall mount.

FIG. 6C is a depiction of the present invention in use with a wheelchair.

FIG. 6D is a depiction of the present invention in use with a stretcher with wire integration.

FIG. 7 is a top perspective view of a second embodiment of the visual alert device of the present invention.

FIG. 8A is an exploded view of the switch assembly of FIG. 7.

FIG. 8B is a side view of the switch assembly of FIG. 7 fully assembled.

FIG. 9 is side exploded view of the ball and electronics assembly of the second embodiment of the present invention.

FIG. 10 is a top view of the light assembly of FIG. 7 with the top lid, ball, and battery cover removed.

FIG. 11 a top view of the light assembly of FIG. 7.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention.

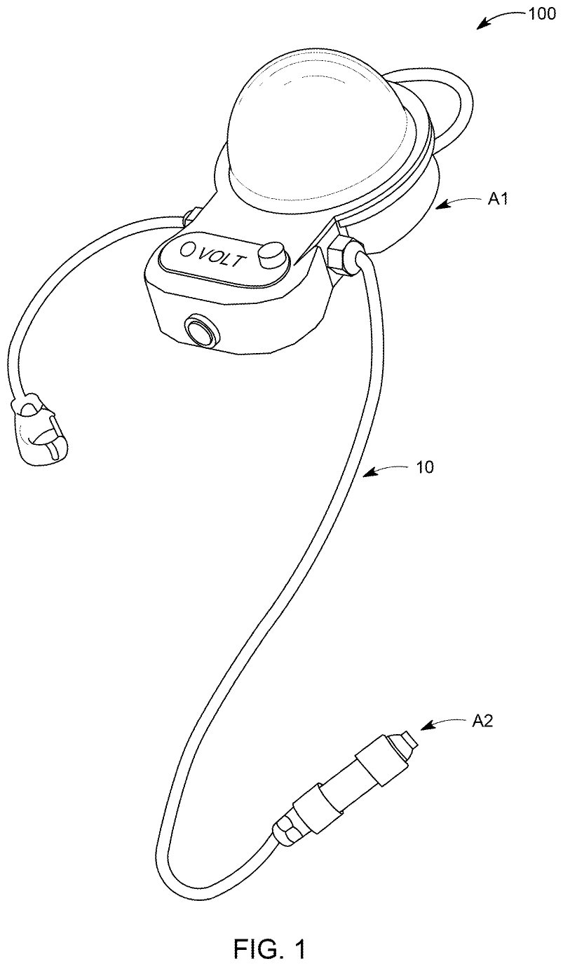

A first embodiment of a visual alert device 100 of the present invention is shown in FIGS. 1-6D. The device 100 provides a simple and quickly deployed visual alert, which may also be referred to as a beacon, that will alert a caregiver such as a hospital staff member, for example, that a person, such as a patient, is in need of attendance. The present invention 100 is designed to be a silent visual cue. This is intended to be used in patient and client care settings where there is a line of sight from the patient holding area to where caregivers may be located. Examples of effective areas to deploy this light device 100 would be in open-bay wards of a military tent hospital, FEMA emergency hospitals in disaster areas, hallways of crowded Emergency Departments, common areas of a residential facility such as a dining area, patio, recreation area, or waiting rooms.

FIG. 1 depicts the device 100 having a ball and electronics assembly A1, a switch assembly A2, and a connector 10. The connector 10 supplies power to the ball and electronics assembly A1 to allow the device 100 to light up. The switch assembly A2 is the control mechanism of the invention that allows the user to control whether the device 100 is on or off.

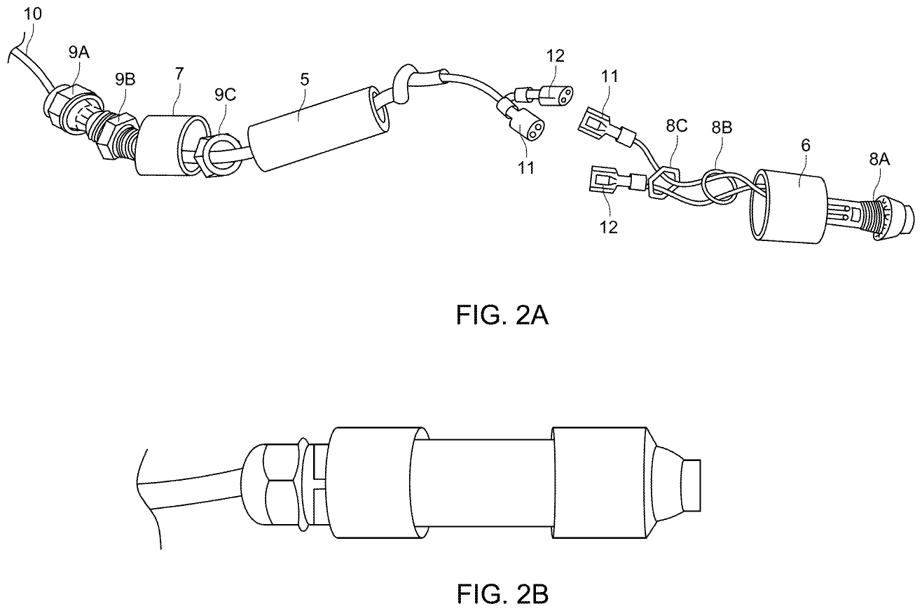

FIGS. 2A and 2B depict the switch assembly A2 of the present device 100. The switch assembly has a switch body 5, an end cap 6, a reducer cap 7, a lock switch 8, and a wire gland 9. The lock switch 8 has a switch portion 8A, a washer 8B, and a retaining nut 8C. The wire gland 9 has an outer nut 9A, a threaded nut 9B, and an inner nut 9C. The wire 10 has a plurality of male connectors 11 and a plurality of female connectors 12.

As depicted in FIG. 2A, the reducer cap 7 and the end cap 6 are coupled to the switch body 5. The wire 10, lock switch 8, male connectors 11, and female connectors 12, are located within the hollow center of the switch assembly A2. The wire 10 enters through the outer nut 9A, through the threaded nut 9B and the inner nut 9C. The wire gland 9 is secured to the reducer cap 7 by the inner nut 9C. The male connectors 11 are connected to the corresponding female connectors 12. The wire 10 further enters the retaining nut 8C, through the washer 8B, ending at the switch portion 8A. The user may control the power to the light assembly A1 by actuating the switch portion 8A of the switch assembly A2.

As depicted in FIG. 2B, when assembled, the reducer cap 7, switch body 5, and end cap 6 are connected together. The wire 10, wire gland, 9, male connectors 11, female connectors 12, retaining nut 8C, and washer 8B are housed within the connected assembly of the reducer cap 7, switch body 5, and end cap 6. The switch portion 8A protrudes from the end cap 6 to allow the user to control the switch assembly A2. The wire 10 extends from the wire gland 9 of the switch assembly A2 to the ball and electronic assembly A1.

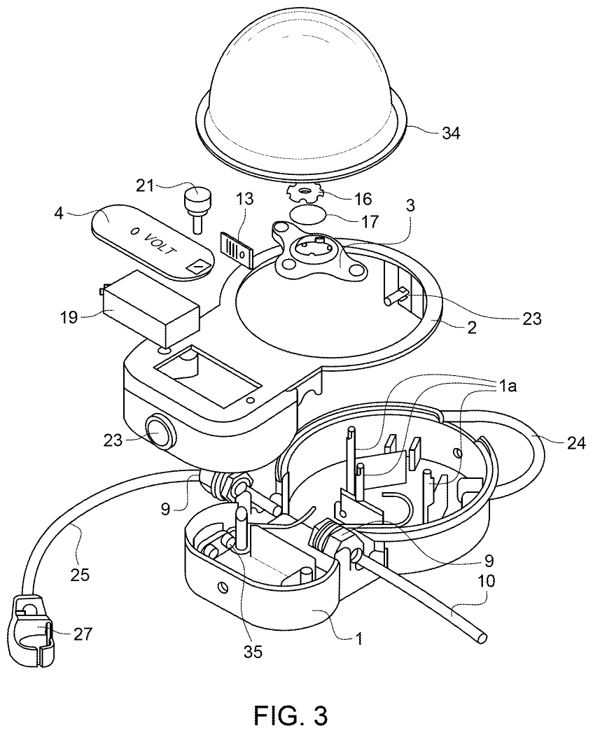

FIG. 3 is an exploded view of the ball and electronic assembly A1. The ball and electronic assembly A1 has a bottom receiver 1, a top cover 2, a mounting plate 3, a battery cover 4, a circuit board 13, a resistor 14, a light 16, a pad 17, a battery 19, a plurality of screws 20, an optional plurality of rivets 23, a loop 24, a cord 25, an optional hook 27, a dome 34, and a battery clip 35. The bottom receiver 1, the dome 34, and the top cover 2 form the main body of the ball and electronic assembly A1. The dome 34 is secured by the attachment of the bottom receiver 1 and the top cover 2. The bottom receiver 1 and the top cover 2 may be attached by a plurality of receiver pins 1a. The bottom receiver 1, the top cover 2, and the dome 34 houses the components of the ball and electronic assembly A1.

As depicted in FIG. 3, the light 16 is located within the dome 34. The light 16 is engaged and removably secured to the pad 17. The pad 17 is secured to the mounting plate 3. The mounting plate is secured to the bottom receiver 1. The light 16 is oriented such that the location causes the dome 34 to illuminate when the light 16 is switched on. The circuit board 13 and resistor 14 are attached to the mounting plate 3 and control the flow of electricity from the switch assembly A2 to the light 16 to control whether the light 16 is on or off. The dome 34 may be made of a plastic or other such material that may be illuminated by the light 16. The battery clip 35 is secured to the bottom receiver 1. The battery clip 35 is configured to removably retain the battery 19. The battery cover 4 is removably engaged with the top cover 2 to secure the battery 19 within the ball and electronic assembly A1. The battery cover 4 may be secured to the top cover 2 with a plurality of screws 21.

As further depicted in FIG. 3, the cord 25 is attached to the bottom receiver 1, and extends from the ball and electronic assembly A1. The loop 24 is attached to the bottom receiver 1 in two locations, oriented to form a loop or ring, which may be used to removably adhere the device 10 to various objects in close proximity to the patient. This may include adherence to a stretcher, wheelchair, bed, railing, the patient's garments, or other objects, as needed. The cord 25 may have an optional hook 27. The hook 27 may be used as an additional or alternative method to removably adhere the device 100 to various objects such as a stretcher, wheelchair, bed, railing, the patient's garments, or other objects, as needed.

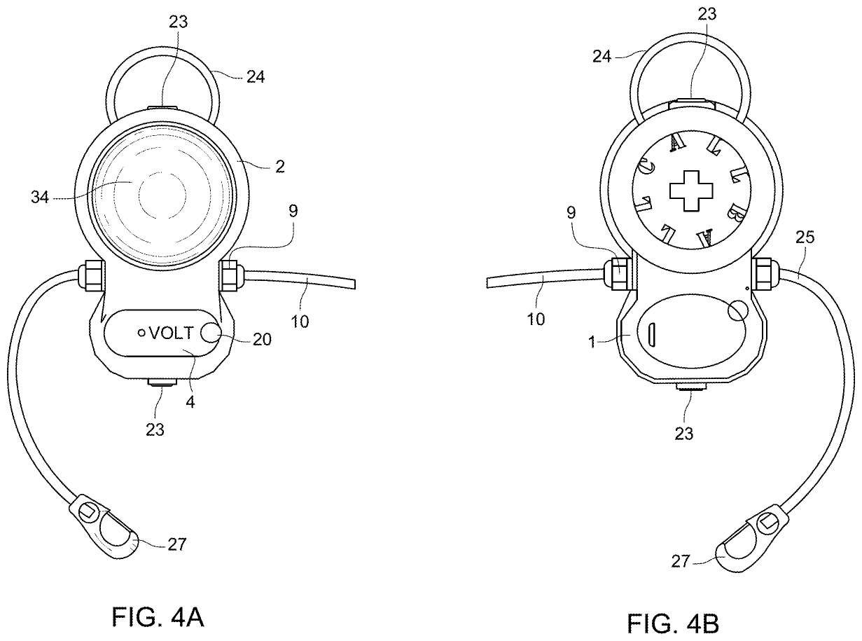

FIGS. 4A and 4B depict the ball and electronic assembly A1. The loop 24 and cord 25 provide multiple methods wherein the user or practitioner may secure the device 100 such that it is in an accessible location if the patient needs to use the device 100. The wire 10 extends to the switch assembly A2 to allow the user control over the illumination of the device 100. The dome 34 is designed to be oriented in a way where staff, practitioners, or other individuals may be able to see the visual cue that the patient needs assistance when the light 16 is illuminated.

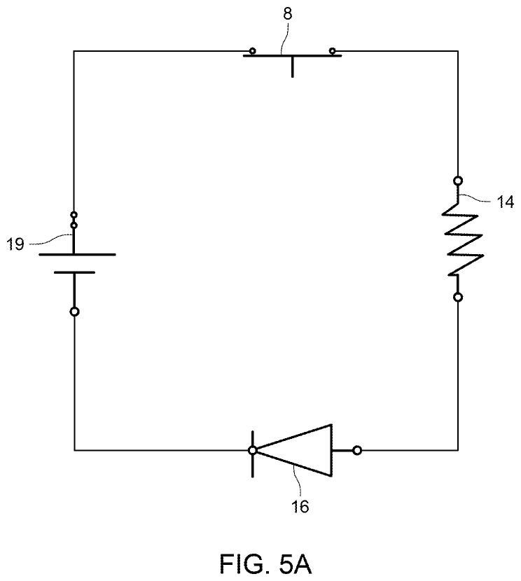

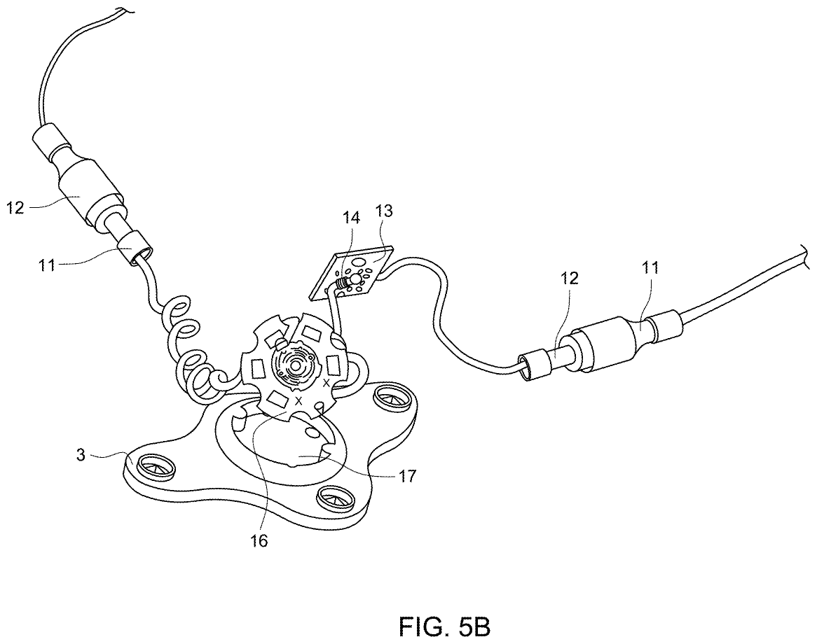

FIG. 5A depicts the circuit schematic of the electrical flow of the device 100. When the switch 8 is engaged, power is drawn from the battery 19. The current flows from the battery 19 through the resistor 14 to the light 16. The circuit is completed with the current flow back to the battery 19. In an embodiment, the switch 8 may be pressed once to turn the light 16 on. Pushing the switch 8 a second time may turn the light 16 off.

FIG. 5B is an exploded view of the electrical components of the device 100. When the user engages the switch portion 8A, a signal is sent through the wire 10 from the switch assembly A2 through the male and female connectors 11, 12 to the circuit board 13 and resistor 14 to the light 16. The current returns to the battery 19 from the light 16, through the wire 10 to complete the circuit.

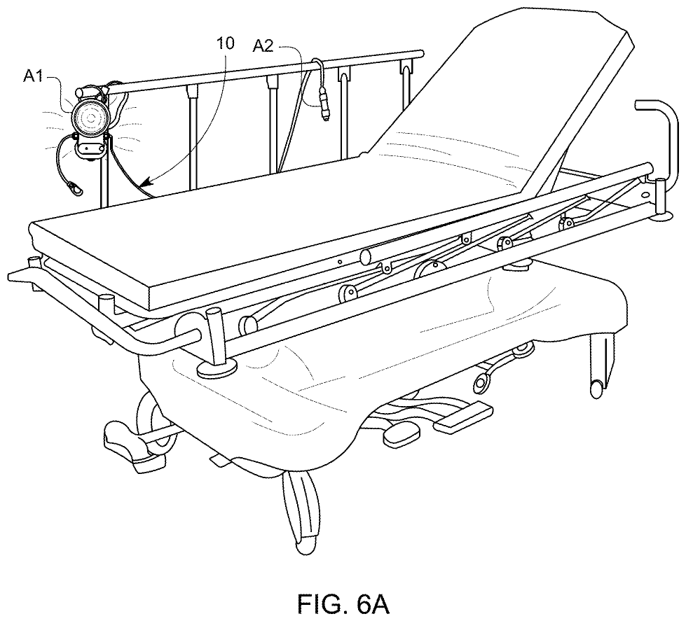

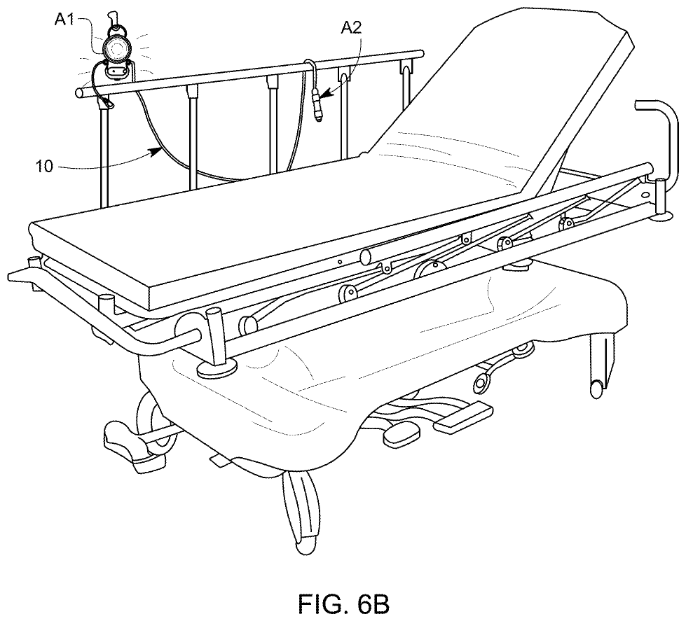

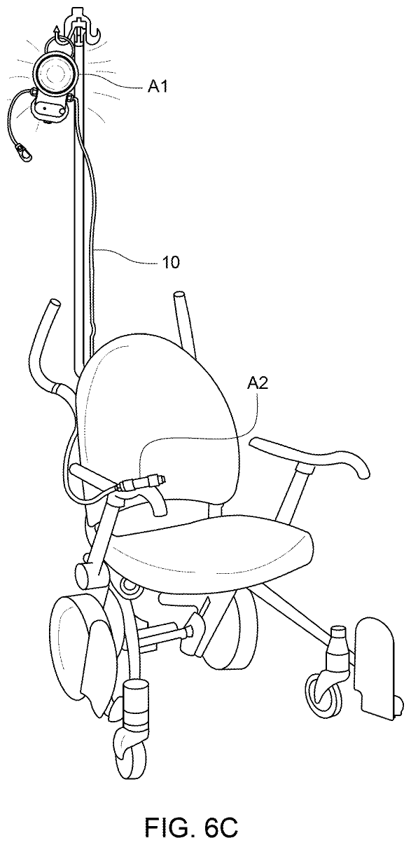

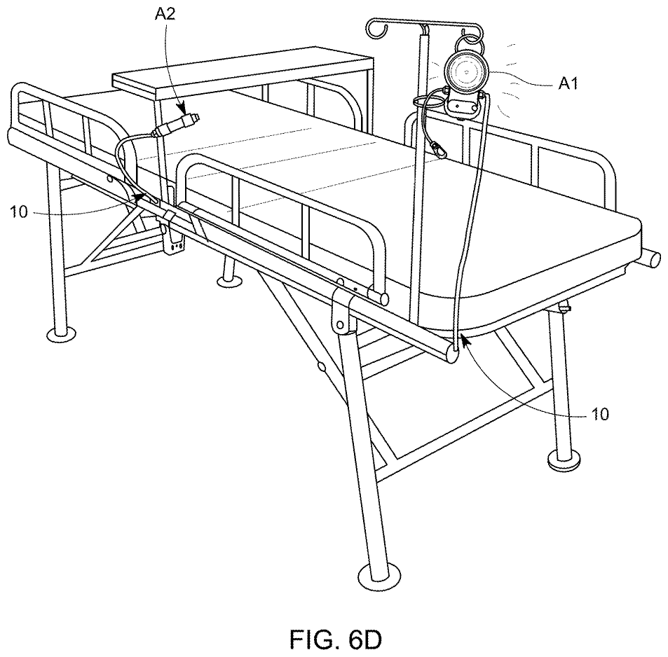

FIGS. 6A-6D depict the first and second embodiments of the device in different use settings. FIG. 6A shows the ball and electronic assembly A1 removably mounted to the rail of a stretcher. The device may be secured to the rail by the loop 24 or hook 27. The switch assembly A2 is located within reach of the patient such that the patient can use the switch portion 8A to turn the light 16 on. FIG. 6B depicts the ball and electronic assembly A1 removably mounted to a hook on a wall. FIG. 6C depicts the ball and electronic assembly A1 removably mounted to a wheelchair. FIG. 6D depicts the ball and electronic assembly A1 removably mounted to an IV pole on a stretcher, wherein the stretcher has wire passages within the rails or framing of the stretcher. The wires 10 of the present invention may be threaded through the wire passages to reduce the risk of the patient dropping or losing the switch assembly A2, or getting tangled in the wires 10. Although FIGS. 6A-6D depict several methods where the device may be used, the use of the device is not limited to only the uses depicted in FIGS. 6A-6D.

The device can be attached to the stretcher, wheelchair, or seat in several ways. Typically, the device will be hooked, clipped, or otherwise attached using loops, hook, and/or clips that may be part of the design of the device 100. In situations where there is a desire to have a more permanent adherence to the bed, stretcher, or other device, it may be possible to mount the ball and electronic assembly A1 and then feed the switch assembly A2 and wire 10 through openings that are wide enough in the stretcher, wheelchair, or seat. The device 100 may also be permanently installed by a qualified electrician or medical/biomedical engineer.

Activation of the light 16 creates a visual cue for a caregiver to observe that a person is in need of attention. The intent is for caregiver to respond to the light 16 and go to the person. The light source of the device is of sufficient intensity to ensure that the caregiver can notice it among other visual effects at the location. In one example, hospital staff who see the visual alert but are not assigned to the patient can find the staff member who is assigned while the light remains on. For the responding nurse or nurse's assistant who is assigned to the patient, they will respond to the patient and shut the light 16 off.

The device 100 of the present invention has a housing 34 to enclose the light 16, which may be a light emitting diode (LED) 16, along with a battery 19, control electronics, and one or more device attachment components. The dome 34 through which the LED 16 shines may be transparent or semi-opaque and forms part of the housing. Solder connections are used at both the LED 16 and resistor 14, all other connections made with male to female spade connectors 11, 12.

The switch assembly A2 that is the control mechanism of the invention allows the patient to control the turning on or off of the light 16. The switch portion 8A is used by the patient to send a signal to the light source 16. The wire 10 carries the signal from the switch portion 8A to the light source 16. In an embodiment, the wire 10 is a 22-gauge wire that runs approximately 6.5 feet from the bottom receiver 1, the top cover 2, and the dome 34 and are encased in a flexible elastomer cover that is manufactured specifically for application in health care settings. The wire 10 may be a 22-2 AWG standard wire covered by an insulated cover and elastomer covering along the entire length of the wire 10. The wire 10 is secured at both the ball and electronic assembly A1 and the switch assembly A2 with the wire gland 9.

In an embodiment, the wiring 10 of the device 100 is positioned along a path where it will not impede normal operation of the stretcher or wheelchair nor cause a potential tripping or tangle hazard. In situations where a more permanent setup of the device 100 is desired, it is possible to secure the device 100 to the desired structure and run the wire 10 and switch assembly A2 through openings that are large enough and safe to do so. If it is desired to embed the device 100 within the interior of a stretcher, wheelchair, or other location that does not have the space required to feed the switch assembly A2 through it, the device 100 may have the accessible switch assembly A2 permanently mounted by an appropriately certified and trained individual, such as an Medical/Biomedical Engineering technician, or Electrician. In permanent installations, the length of the wire 10 may be variable to accommodate desired locations of the switch assembly A2 and the ball and electronic assembly A1.

In some embodiments, the device 100 has a permanently closed switch assembly A2. The switch assembly A2 is intended to be placed easily within the patient's reach, either handed (i.e., left or right) to the patient to be used as needed or clipped to their garment or convenient location of the surface they are in stretcher, wheelchair, seat, or other device.

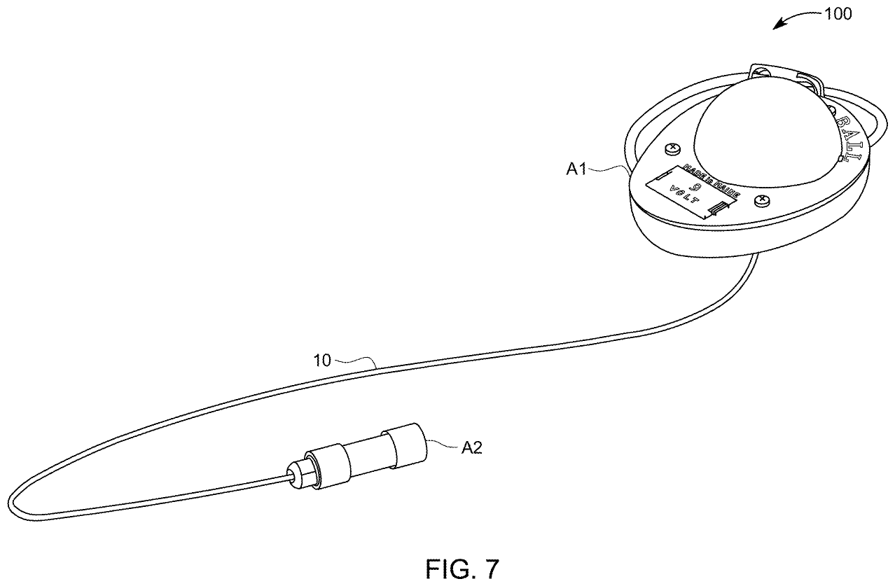

A second embodiment of a visual alert device 100′ is shown in FIGS. 7-11. The second embodiment of the invention functions in the same manner as the first embodiment with some modest variants in configuration as described herein. For example, FIG. 7 shows the updated external appearance of the ball and electronics assembly A1.

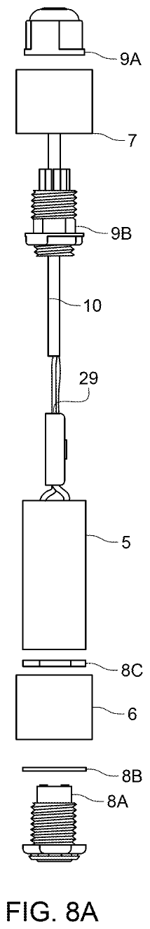

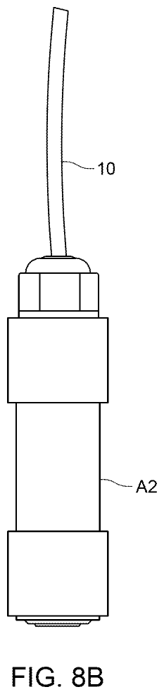

FIG. 8A is an update of FIG. 2A, wherein the inner nut 9C has been eliminated from the first embodiment shown in FIG. 2B. In addition, in the second embodiment, the threaded nut 9B that lies within reducer cap 7, the male connectors 11 and the female connectors 12 have been eliminated. In addition, the wire 10 enters crimp connector 29 and exits the other side of crimp connector 29, further enters retaining nut 8C, through endcap 6, through washer 8B, ending at the switch portion 8A. This differs from the first embodiment shown in FIG. 2B in the position of washer 8B. FIG. 8B further shows a different construct than is shown in FIG. 2B for the first embodiment of the invention in the external appearance of gland outer cap 9A and the repositioning of threaded nut 9B to the inside of the switch assembly A2.

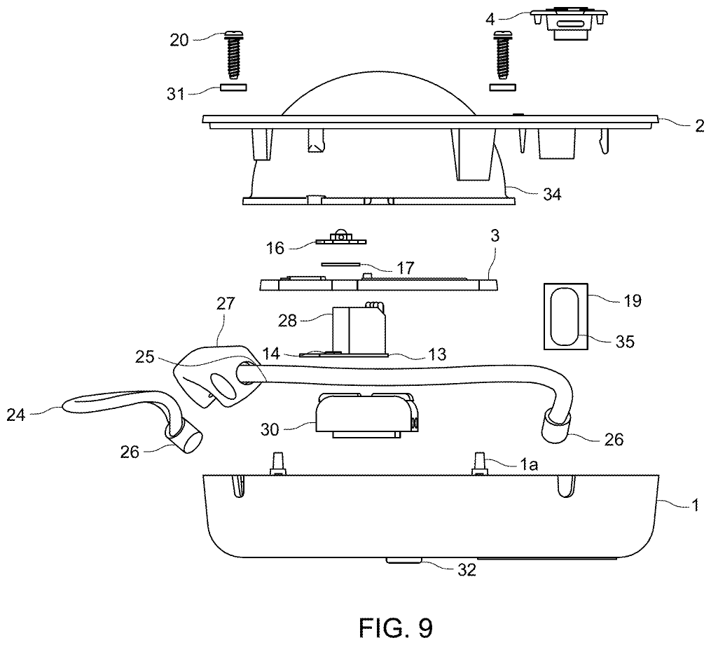

FIG. 9 shows a difference in the second embodiment of the invention as compared to the first embodiment when considering FIG. 3. FIG. 9 shows the device 100′ without the battery cover screw 21 and rivets 23 that have been removed. In addition, in the second embodiment, the following parts have been reconfigured from their appearance in the first embodiment shown in FIG. 3: bottom receiver 1, top cover 2, mounting plate 3, battery cover 4, circuit board 13, resistor 14, and dome 34. Specifically, the body of the second embodiment of the device 100′ is egg-shaped as compared to the rounded and stem construct of the device 100 of FIG. 1. Further, the bottom receiver 1 of the device 100′ is more bowl-shaped, the top cover 2 has a flat surface, the mounting plate 3 is elongated and narrower than that of device 100, the battery cover 4 for device 100′ is a flat, clip-in lid that articulates with the top lid surface, providing access on the top of the top lid, the circuit board 13 is a printed circuit board in device 100′ using surface-mounted resistors and wire connectors, the resistor 14 are on the printed circuit board, and the dome 34 of device 100′ has notches and projections added. In addition, components that have been added in the second embodiment are: a rubber grommet 32 has been added to replace the gland 9 from FIG. 3 as the entry point for wire 10 to the ball and electronics assembly A1. Added to the top lid fastener is washer 31. A crimp sleeve 26 has been added to the ends of top loop 24 and side hook 25. Internal wire connector 30 and circuit board surface mount wire connector 28 have been added and take the place of the male connectors 11 and the female connectors 12 of the first embodiment.

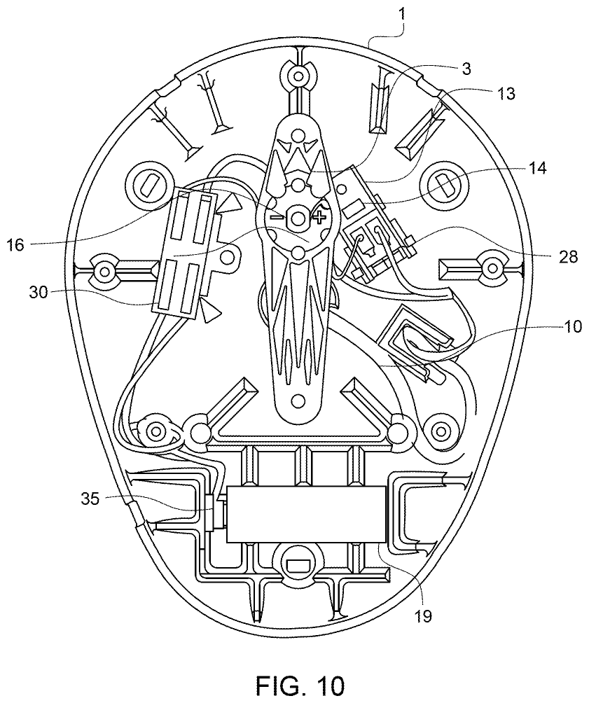

FIG. 10 depicts the internal components of the second embodiment located in their assembled positions and the path of wire 10 as it lies in the bottom receiver.

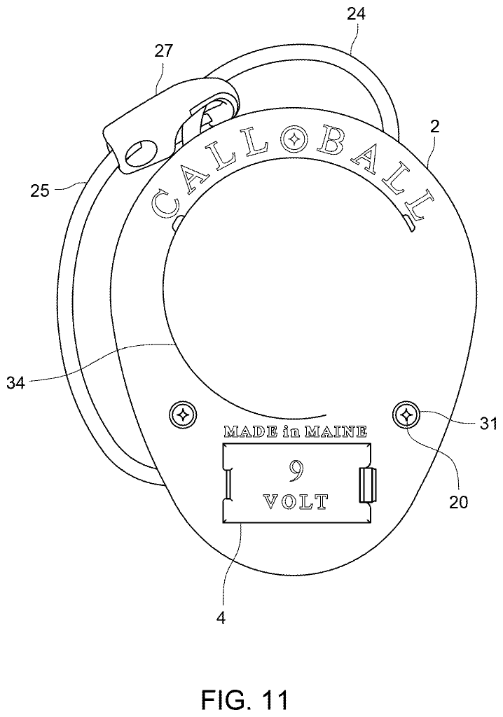

FIG. 11 shows the top view of all components of the second embodiment of the device 100′.

The present invention has been described with reference to specific examples and configurations. It is only intended to be limited to the description set out in the claims and equivalents.

What is claimed is:

1. A visual alert device comprising:
a light source;
a power source coupled to the light source;
a control mechanism coupled to the power source; and
an attachment mechanism for attaching the light source to a structure.

2. The system of claim 1 wherein the light source is an LED light.

3. The system of claim 1 wherein the power source is a battery.

4. The system of claim 1 wherein the control mechanism is a button or a switch.

5. The system of claim 1 wherein the attachment mechanism is a strap, latch, hook, or other method of removable attachment.

6. The system of claim 1 wherein the attachment mechanism is glue, welding, or other method of permanent attachment.
